(19) United States
(12) Patent Application Publication
(10) Pub. No.: US 2005/0046209 A1
(43) Pub. Date: Mar. 3, 2005

(54) Arrow remover

(76) Inventor: Howard Bessette, Solvang, CA (US)

Correspondence Address: FELIX L. FISCHER, ATTORNEY AT LAW, 1607 MISSION DRIVE, SUITE 204, SOLVANG, CA, 93463, US

(21) Appl. No.: 10/649,709

(22) Filed: Aug. 26, 2003

(51) Int. Cl. B65G 7/12; B25B 9/00

(52) U.S. Cl. 294/1.1

(57) ABSTRACT

An arrow remover incorporates a main body sized for grasping within the palm and fingers of a users hand, the main body having a substantially flat front surface. First and second cams are rotatably mounted to the front surface to receive an arrow shaft positioned substantially flat upon the front surface. The cams frictionally engage the inserted arrow shaft. A spring for resiliently urging the first cam and second cam to a closed position allows automatic one handed operation of the invention.

### BACKGROUND OF THE INVENTION

1. Field of the Invention

This invention relates generally to the field of archery implements and, more particularly, to a device for frictional engagement of the shaft of an arrow between two cams mounted on the flat surface of a convenient hand sized grasping body for extraction of the arrow from a target.

2. Description of the Related Art

Archery, whether for target shooting or hunting, requires the removal of a spent arrow from its target. Very often the embedded arrow requires significant force to remove and the frictional purchase on the shaft by a bare hand is insufficient. Numerous devices have been developed to allow mechanical leverage to increase the friction or force which can be applied to the arrow. A simple pair of pliers can be used to extract an arrow in some cases, however, the jaws of the pliers can mar the arrow shaft and the offset angle required to grip the shaft can result in shaft breakage or insufficient leverage to maintain a grip on the shaft.

It is, therefore, desirable to have a compact device easily gripped within the hand which frictionally engages the arrow shaft in a collinear manner to ease extraction of an embedded arrow.

### SUMMARY OF THE INVENTION

An arrow remover embodying the present invention incorporates a main body sized for grasping within the palm and fingers of a users hand, the main body having a substantially flat front surface. First and second cams are rotatably mounted to the front surface, the cams rotatable from a closed position through an intermediate position to an open position. In the open position adequate separation is present between the cams to receive an arrow shaft positioned substantially flat upon the front surface. At the intermediate position, the cams frictionally engage the inserted arrow shaft and the closed position providing no greater separation between the cams than a shaft diameter of the smallest shaft arrow intended for use. A spring for resiliently urging the first cam and second cam to the closed position allows automatic one handed operation of the invention.

### BRIEF DESCRIPTION OF THE DRAWINGS

These and other features and advantages of the present invention will be better understood by reference to the following detailed description when considered in connection with the accompanying drawings wherein:

FIG. 1 is a front isometric view of an embodiment of the invention;

FIG. 2a is a front view of the embodiment of FIG. 1 with the cams in the closed position;

FIG. 2b is a front view with an arrow shaft engaged between the cams;

FIG. 2c is a front view with one cam in the closed position and one cam in the open position shown in phantom to view the actuation mechanism;

FIG. 3 is an end view of the embodiment showing the arrow tip engagement depression; and

FIG. 4 is a front view of a second exemplary embodiment of the invention demonstrating with one cam in the closed position and one cam in the open position in phantom to show an alternative cam actuation mechanism.

### DETAILED DESCRIPTION OF THE INVENTION

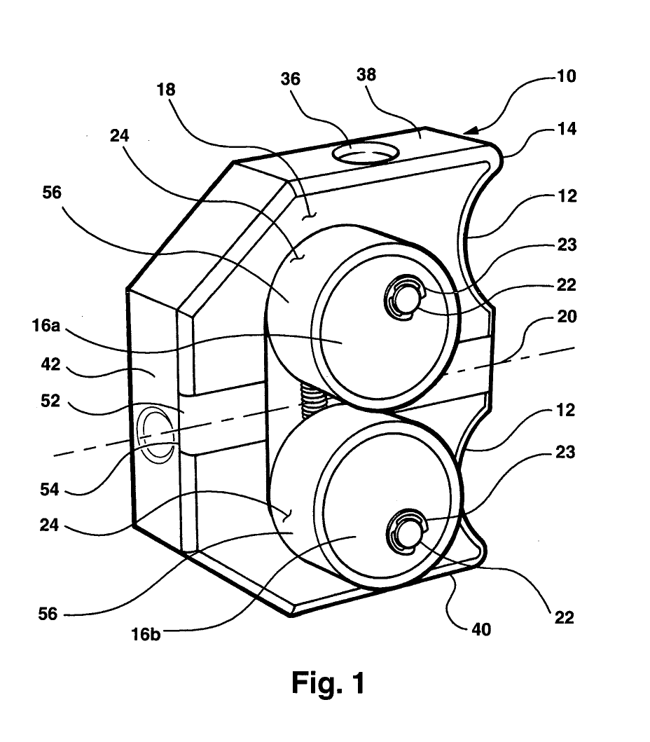

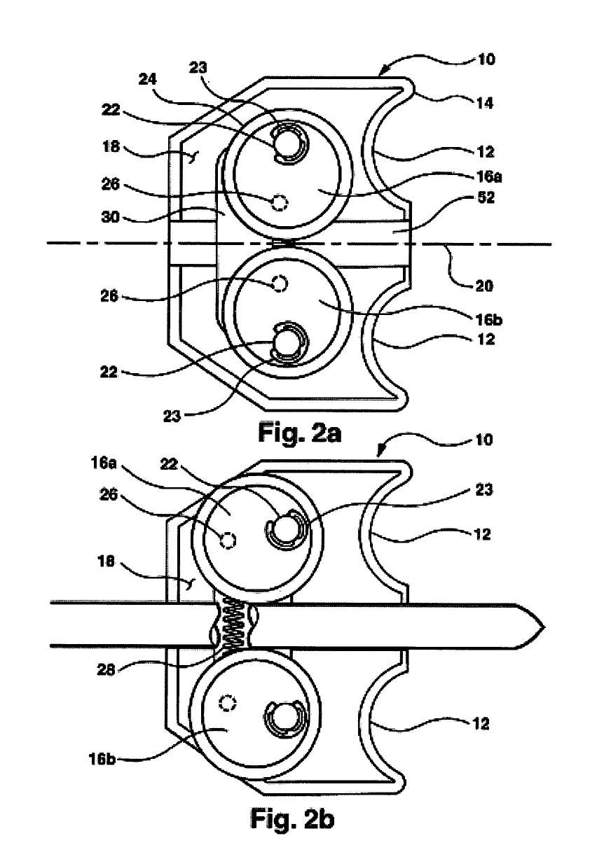

Referring to the drawings, a first embodiment of the invention is shown in FIG. 1. A main body 10 is sized to be conveniently held within the palm of a user. Contours 12 along a forward edge 14 of the body are sculpted to provide finger grips. Two circular cams 16a and 16b are mounted to the front surface 18 of the body equidistantly spaced from a center line 20 extending substantially perpendicular to the forward edge along the front surface. In the embodiment shown, the cams are mounted with off center axles 22 received in bores in the front surface, as will be described in greater detail subsequently. For the embodiment shown in the drawings, the axle is press fit into the bore and the cam is retained on the axle by a circlip 23. Rotation of the cams about the axles allows a range of motion from a fully open position with maximum separation between the adjacent tangency points parallel to the center line on the circumferences of the cams through a fully closed position with the cams with the tangency points parallel to the center line having closest proximity as shown in FIG. 2a.

With the cams in the open position, the shaft of an arrow embedded in a target can be placed between the circumferential surfaces 24a and 24b of the cams flush with the front surface of the body and substantially parallel to the center line. The cams then rotate toward the closed position to engage the shaft of the arrow between the circumferential surfaces which frictionally engage the shaft as shown in FIG. 2b. The off-center axles are positioned relative to the center line to maximize the moment created by tangential friction between the arrow and cam within the constraints of accommodating various shaft diameters. The user can then grasp the body, placing his or her fingers into the sculpted finger grips and extract the arrow from the target. The device can be used either right or left handed by positioning the body on the desired side of the arrow shaft.

As shown in FIG. 2c for a first embodiment of the invention, the cams each incorporate a pin 26 positioned substantially diametrically opposite from the axle. The pin provides an attachment point for a spring 28 which urges the pins together thereby rotating the cams toward the closed position. A relief 30 machined in the front surface allows for movement of the pins and shielding of the spring below the front surface. A side surface of the relief also provides a first abutment 32 to engage the pin in the open position preventing further rotation of the cam as shown for the cam 16b in phantom. A second abutment 34 is provided by a second side surface of the relief to engage the pin in the closed position thereby maintaining some tension on the spring and preventing further rotation of the cams as shown for the cam 16a in phantom. For the embodiment shown, the relief is machined with rounded side surfaces to be substantially covered by the cams. Alternate embodiments employ different relief shapes to simplify machining or to provide specific abutment locations to closely control the open and closed positions of the cams. The length and spring constant of the spring are predetermined to provide relative ease of opening the cams for insertion of the arrow shaft while maintaining sufficient closure force to assist the frictional engagement of the cams with the shaft.

For the embodiment shown in the drawings, cam diameters of approximately 26 mm are employed. The axle is offset approximately 7 mm from the cam center providing a 19 mm moment arm at the maximum tangency point for engagement of an arrow shaft. A 5 mm diameter axle is employed. For the embodiment shown, the pin on each cam is also offset approximately 7 mm from the cam center diametrically opposite from the axle. For the exemplary embodiment, the cam axles are spaced 40 mm from centerline to centerline providing a spacing of 2 mm between the circumferences of the cams in the closed position.

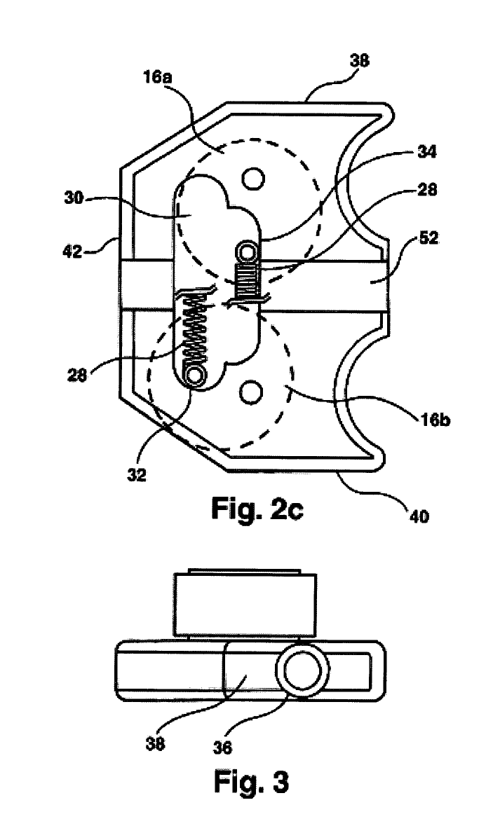

The present invention also provides for preparation of an arrow for extraction which has completely penetrated the target. As shown in FIG. 3, a conical depression 36 is machined in a side surface 38 of the body. The tip of the arrow head is placed in the conical depression and the body is grasped with the heel of the hand against an opposite side surface 40 to urge the arrow back into the target. This provides the maximum length of shaft extending from the front side of the target to allow attachment of the cams to the shaft for extraction of the arrow. Placement of the conical depression is shown in a side surface for the embodiment shown in the drawings. In alternative embodiments, the conical depression is placed in the forward edge of the body between the sculpted grips or above the grips with side surface 42 providing the pressure point for the heel of the hand. Similarly, in yet other alternative embodiments, the conical depression is provided in the side surface 42 as shown in phantom in FIG. 1.

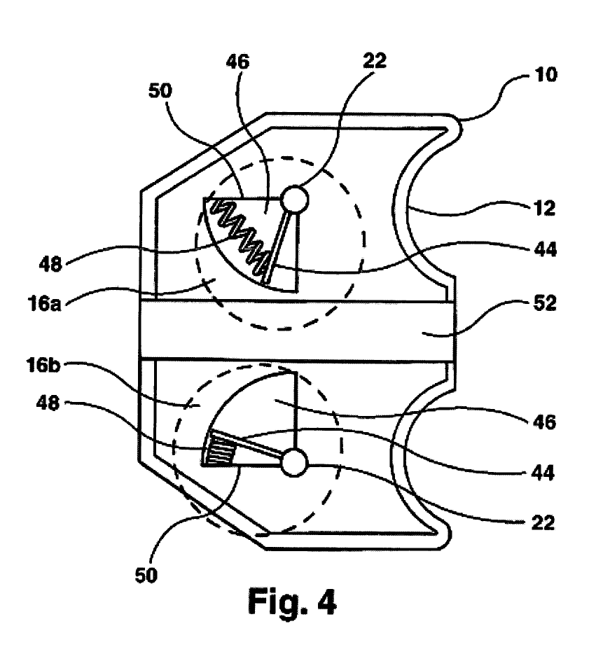

An alternative embodiment of the invention is shown in FIG. 4. The pins of the previously described embodiment are eliminated and a lever 44 extends from the axle on each cam. A semi-circular relief 46 provides for travel of the lever during rotation of the cam and a spring 48 is engaged in compression between the lever and an end wall 50 of the relief, urging the lever to rotate the axle into the closed position of the cam as shown in phantom for cam 16a. The cam in the open position results in compression of the spring to stop further opening of the cam as shown in phantom for cam 16b. In this embodiment, the lever and spring actuation system is completely shielded by the cam. While a coil spring is shown in the embodiment in the drawings, a leaf or V spring or a compound combination of hinged V spring and compression coil spring engaging the legs of the V is employed in alternative embodiments of the invention.

For both the embodiments shown in the drawings, a resilient strip 52 is inserted in a groove 54 in the front surface of the body along the center line. This resilient strip prevents marring of the arrow shaft by the front surface with the arrow engaged between the cams. The strip further provides additional friction to assist in preventing slippage of the arrow when engaged by the cams. Additionally, the circumferential surfaces 24 of the cams are covered with a resilient high friction strip 56 to prevent marring of the arrow shaft and enhance the gripping power of the cams on the shaft. A rubber O-ring or similar device has been shown to be operative for this function.

Having now described the invention in detail as necessary by the patent statutes, those skilled in the art will recognize modifications and substitutions to the specific embodiments disclosed herein. Such modifications are within the scope and intent of the present invention as defined in the following claims.

1. An arrow remover comprising:
a main body sized for grasping within the palm and fingers of a users hand, the main body having a substantially flat front surface;
first and second cams rotatably mounted to the front surface, the cams rotatable from a closed position through an intermediate position to an open position, the open position providing adequate separation between the cams to receive an arrow shaft positioned substantially flat upon the front surface, the intermediate position frictionally engaging the inserted arrow shaft and the closed position providing no greater separation between the cams than a shaft diameter of the smallest shaft arrow intended for use.

2. An arrow remover as defined in claim 1 further comprising means for resiliently urging the first cam and second cam to the closed position.

3. An arrow remover as defined in claim 1 wherein the main body incorporates finger cutouts on a first edge substantially perpendicular to an axis parallel to an arrow shaft received between the cams.

4. An arrow remover as defined in claim 1 further comprising a pliable strip inlaid into the front surface intermediate the first and second cams along an axis parallel to an arrow shaft received between the cams to avoid marring of the arrow shaft.

5. An arrow remover as defined in claim 1 wherein a circumferential surface of each cam includes means for enhancing the friction coefficient for engagement between the cam and arrow shaft.

6. An arrow remover as defined in claim 5 wherein the friction coefficient enhancing means is pliable to avoid marring of the arrow shaft.

7. An arrow remover as defined in claim 1 wherein the first and second cams are substantially circular and each cam is mounted to the main body with an off-center axle.

8. An arrow remover as defined in claim 7 wherein the first and second cams each have a pin extending substantially parallel to the axle and diametrically aligned therewith, and the main body further including a relief receiving the pin from each cam, the cams rotatable from a closed position through an intermediate position to an open position, the open position providing adequate separation between the cams to receive an arrow shaft positioned substantially flat upon the front surface, the intermediate position frictionally engaging the inserted arrow shaft and the closed position placing a circumferential surface of each cam in tangential contact with the arrow shaft and further comprising:
a spring engaging the pin from each cam within the relief to resiliently urge the pins from a first displaced position corresponding to the open position of the first and second cams to a second proximate position corresponding to the closed position of the first and second cams.

9. An arrow remover as defined in claim 1 further comprising a depression on a side of the main body to engage an arrow tip extending through a target and a pressure surface on the main body opposite the side containing the depression to allow the arrow tip engaged in the depression to be pressed into the target.

10. An arrow remover as defined in claim 7 wherein each off-center axle incorporates a lever extending substantially perpendicular from the axle distal the cam, and the main body includes a bore to receive each off-center axle and a semi-circular relief extending from the bore to receive the lever, and further comprising a spring engaged within the relief to resiliently urge the lever from a first position corresponding to the open position of the first and second cams to a second position corresponding to the closed position of the first and second cams.

11. An arrow remover comprising:
a main body sized for grasping within the palm and fingers of a users hand, the main body having a substantially flat front surface;
first and second substantially circular cams rotatably mounted to the front surface, each cam having an off-center axle engaged in a bore in the front surface, a pin extending substantially parallel to the axle and diametrically aligned therewith, and the main body further including a relief receiving the pin from each cam, the cams rotatable from a closed position through an intermediate position to an open position, the open position providing adequate separation between the cams to receive an arrow shaft positioned substantially flat upon the front surface, the intermediate position frictionally engaging the inserted arrow shaft and the closed position placing a circumferential surface of each cam in tangential contact, a circumferential surface of each cam including a pliable means for enhancing the friction coefficient for engagement between the cam and arrow shaft to avoid marring of the shaft;
a spring engaged within the relief to resiliently urge the pins from a first displaced position corresponding to the open position of the first and second cams to a second proximate position corresponding to the closed position of the first and second cams;
the main body further incorporating finger cutouts on a first edge substantially perpendicular to an axis parallel to an arrow shaft received between the cams and having a pliable strip inlaid into the front surface intermediate the first and second cams along an axis parallel to the arrow shaft received between the cams to further avoid marring of the arrow shaft; and,
a side of the main body further containing a depression to engage an arrow tip extending through a target and a pressure surface on the main body opposite the side containing the depression to allow the arrow tip engaged in the depression to be pressed into the target
